(19) United States
(12) Patent Application Publication
(10) Pub. No.: US 2016/0276901 A1
(43) Pub. Date: Sep. 22, 2016

(54) ROTARY ELECTRIC MACHINE

(71) Applicants: TOYOTA JIDOSHA KABUSHIKI KAISHA, Toyota-shi, Aichi-ken (JP); AISIN AW CO., LTD., Anjo-shi, Aichi-ken (JP)

(72) Inventors: Masakazu NAGAISHI, Toyota-shi, Aichi-ken (JP); Taketo TAKEUCHI, Nishio-shi, Aichi-ken (JP); Takafumi OGISU, Anjo-shi, Aichi-ken (JP)

(73) Assignees: TOYOTA JIDOSHA KABUSHIKI KAISHA, Toyota-shi, Aichi-ken (JP); AISIN AW CO., LTD., Anjo-shi, Aichi-ken (JP)

(21) Appl. No.: 15/032,777

(22) PCT Filed: Oct. 27, 2014
(86) PCT No.: PCT/IB2014/002232

§ 371 Date: Apr. 28, 2016

(30) Foreign Application Priority Data
Nov. 1, 2013 (JP) 2013-228488

(51) Int. Cl. H02K 9/00

(52) U.S. Cl. CPC H02K 9/00

(57) ABSTRACT

A rotary electric machine includes a case, a cover, and a cooling pipe. The case houses a rotor and a stator, and the case has an opening at one end of the case in an axis direction of the rotor. The cover is fixed to a peripheral edge of the opening of the case. The cover is configured to cover the opening. The cooling pipe is placed adjacent to the stator inside the case. The cooling pipe extends in the axis direction. One end of the cooling pipe is configured to abut on a back surface of the cover via an elastic member, and the other end of the cooling pipe is fastened and fixed to the case.

### BACKGROUND OF THE INVENTION

1. Field of the Invention

The present invention relates to a rotary electric machine (motor).

2. Description of Related Art

In recent years, hybrid vehicles have been widely used, and drive motors used in the hybrid vehicles have been also improved. Although not peculiar to the hybrid vehicles, a motor with a high output is easy to become a source of vibration.

Further, it has nothing to do with the vibration of the motor, but a drive motor for an electric vehicle has a large output and also has a large amount of heat generation. Japanese Patent Application Publication No. 2013-027229 (JP 2013-027229 A) describes a motor including a cooling pipe inside a case. The cooling pipe is placed along a stator. A plurality of holes is provided in the cooling pipe, so that refrigerant is discharged from the holes toward the stator so as to cool the stator.

### SUMMARY OF THE INVENTION

In most motors, a case for accommodating a rotor and a stator therein is configured such that one end thereof in a rotor axis direction is opened, and the opening is covered with a cover. Generally, that side of the case which is opposite to a side where a shaft projects, that is, a rear end of the case is opened. For the motor provided in a vehicle, lightweighting is also an important factor, and its case and cover are also thinned as much as possible. According to the examination of inventors, it is found that a cover fixed to a peripheral edge of an opening of a case is generally easy to vibrate like a diaphragm. A technique described in the present specification realizes a low-vibration motor at a low cost by using a cooling pipe for supplying refrigerant to cool a stator, for vibration restraint of a cover.

A rotary electric machine according to one aspect of the present invention has the following configuration. A rotary electric machine includes a case, a cover, and a cooling pipe. The case houses a rotor and a stator in the case and the case has an opening at one end of the case in an axis direction of the rotor. The cover is fixed to a peripheral edge of the opening of the case. The cover is configured to cover the opening. The cooling pipe is placed adjacent to the stator inside the case. The cooling pipe extends in the axis direction. One end of the cooling pipe is configured to abut on a back surface of the cover via an elastic member, and the other end of the cooling pipe is fastened and fixed to the case.

The technique described in the present specification realizes a low-vibration motor at a low cost by using a cooling pipe originally provided in the motor, for vibration restraint of a cover.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a drawing of a longitudinal section of a motor of an embodiment;

FIG. 2 is a view of the motor of the embodiment when viewed in an axis direction;

FIG. 3 is an enlarged sectional view of a cooling pipe and a peripheral area of a fixed portion thereof; and

FIG. 4 is an enlarged perspective view of the fixed portion of the cooling pipe.

### DETAILED DESCRIPTION OF EMBODIMENTS

As described above, the motor described in JP 2013-027229 A includes: a case for accommodating a rotor and a stator therein; a cover for covering an opening of the case; and a cooling pipe. One end (a rear end) of the case in a rotor axis direction is opened. The cover is fixed to a peripheral edge of an opening of the case, so as to cover the opening. The cooling pipe is placed adjacent to the stator inside the case, and extends in the rotor axis direction. A plurality of holes for discharging refrigerant is provided on a side surface of the cooling pipe, so that refrigerant supplied from one end of the cooling pipe is discharged toward the stator from the holes. Note that the refrigerant is lubricant in the case.

In the motor of JP 2013-027229 A, one end of the cooling pipe is press-fitted into a back surface of the cover via an elastic member, and the other end thereof abuts with the case. In other words, the cooling pipe is supported such that the cooling pipe is sandwiched by the case and the cover. A motor described in the present invention has a different support structure for a cooling pipe, and is improved so that the cooling pipe contributes to vibration restraint. That is, the motor described in the present invention is configured such that one end of the cooling pipe abuts with a back surface of a cover via an elastic member or the one end of the cooling pipe is fixed thereto, and the other end thereof is fastened and fixed to a case. The fixation to the case is made preferably by bolt fastening.

When the cover vibrates, that one end of the cooling pipe which abuts with (is fixed to) the back surface of the cover presses the cover in a vibration direction. Hence, if the cooling pipe is firmly fixed to the case, the cooling pipe functions as a vibration control member. In the technique of JP 2013-027229 A, the cooling pipe is just sandwiched between the cover and the case. However, in this configuration, the cooling pipe also vibrates along with the vibration of the cover, so that an effect of vibration control is hardly obtained. On the other hand, according to the examination of the inventors, when the cooling pipe is just fixed to the case, it is possible to obtain a remarkable vibration reduction effect.

Note that, when a rib is provided in the other end (that end of the cooling pipe which is fixed to the case) of the cooling pipe, the vibration reduction effect is further increased. Further, when the cooling pipe is held between the case and the cover, an elastic member may be press-fitted into a press-fitting hole provided on the back surface of the cover, so that the elastic member receives a compressive load.

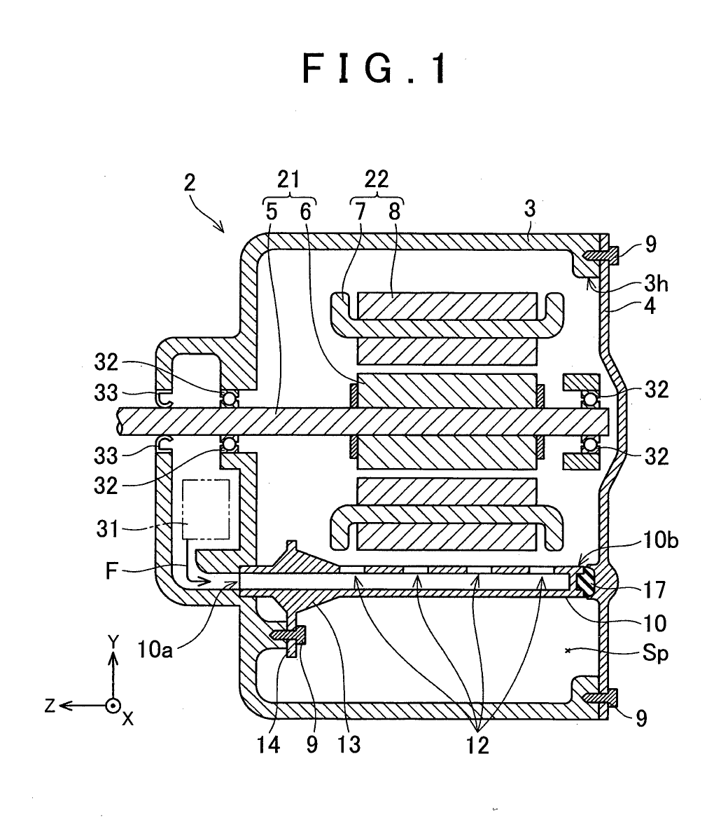

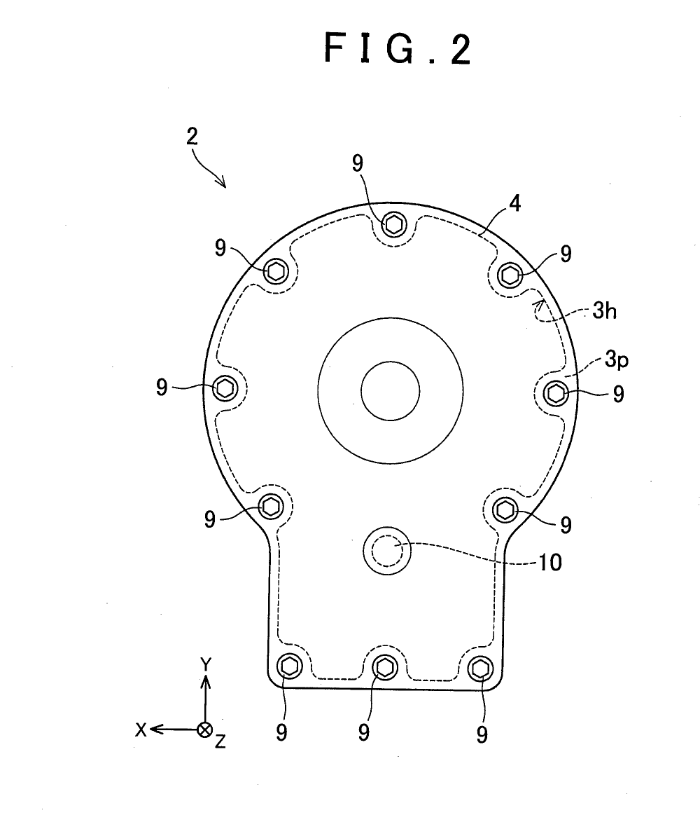

The following describes a motor according to an embodiment with reference to the drawings. A motor 2 of the embodiment is a drive motor for an electric vehicle. FIG. 1 is a drawing of a longitudinal section of the motor 2 (a sectional view thereof along a rotor axis), and FIG. 2 is a view of the motor 2 when viewed in an axis direction. A Z-axis direction in the figure corresponds to a rotor axis direction. Note that, since a case 3 of the motor 2 has a space Sp where a terminal and the like (not shown) is accommodated, the figure (FIG. 2) thereof when viewed in the axis direction is not circular.

The motor 2 is configured such that a rotor 21 and a stator 22 are accommodated in the case 3. The rotor 21 is constituted by a rotor core 6, and a shaft 5 passed through a center of the rotor core 6. The rotor core 6 is obtained by laminating a plurality of magnetic steel sheets. The shaft 5 is rotatably supported by bearings 32 attached to the case 3. Note that a reference sign 33 in the figure indicates a sealer that seals between the case 3 and the shaft 5 that rotates. The stator 22 is constituted by a stator core 8 and a coil 7. The stator core 8 is also formed by laminating magnetic steel sheets.

Note that the shaft 5 extends in a positive direction of Z in FIG. 1, and a gear wheel and the like is connected to the shaft 5. For purposes of the description, the left side (the positive direction of the Z-axis) of the motor 2 is referred to as a “front side” in FIG. 1, and the right side (a negative direction of the Z-axis) of the motor 2 is referred to as a “rear side.” FIG. 2 corresponds to a view of the motor 2 when viewed from the rear side in the axis direction.

A rear end of the case 3 in the rotor axis direction is opened, and a rear cover 4 covers an opening 3h thereof. As understood from FIGS. 1 and 2, the rear cover 4 is fixed to a peripheral edge 3p of the opening 3h of the case 3 with bolts 9. That is, a central portion of the rear cover 4 is not supported by the case 3. Since lightweighting of devices provided in the vehicle is also important, the case 3 and the to rear cover 4 are formed as thin as possible. The case 3 and the rear cover are made of metal (typically, aluminum). The rear cover 4 configured such that its periphery is fixed and its central portion is not supported may vibrate like a diaphragm. In the motor 2 of the embodiment, vibration of the rear cover 4 is restrained by use of a cooling pipe 10 for cooling the stator 22.

Next will be described the cooling pipe 10. The cooling pipe 10 is an elongated hollow pipe extending in the rotor axis direction, and is placed outside the stator 22 (on a side opposite to the rotor 21 when viewed from the stator 22). A motor-front-side end 10a of the cooling pipe 10 is opened, and a motor-rear-side end 10b thereof is closed. The front end 10a is connected to a pump 31 provided in a front of the motor, and refrigerant is force-fed from the pump 31. An arrow indicated by a reference sign F in FIG. 1 indicates a flow of the refrigerant. Note that, in FIG. 1, a structure of the pump 31 is not illustrated, and is illustrated just in a simple rectangular shape with a virtual line.

The cooling pipe 10 is provided with a plurality of holes 12 toward the stator 22. The refrigerant force-fed from the pump 31 is discharge from the holes 12 toward the stator 22. Thus, the refrigerant is discharged toward the stator 22 at appropriate intervals, so that the stator 22 is cooled by the refrigerant. Note that the refrigerant is lubricant sealed inside the case 3.

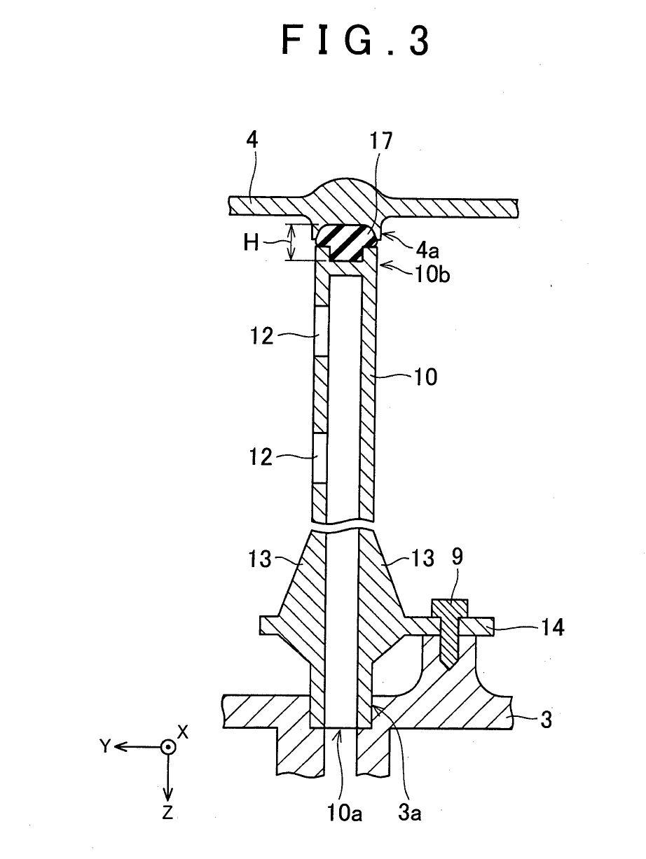

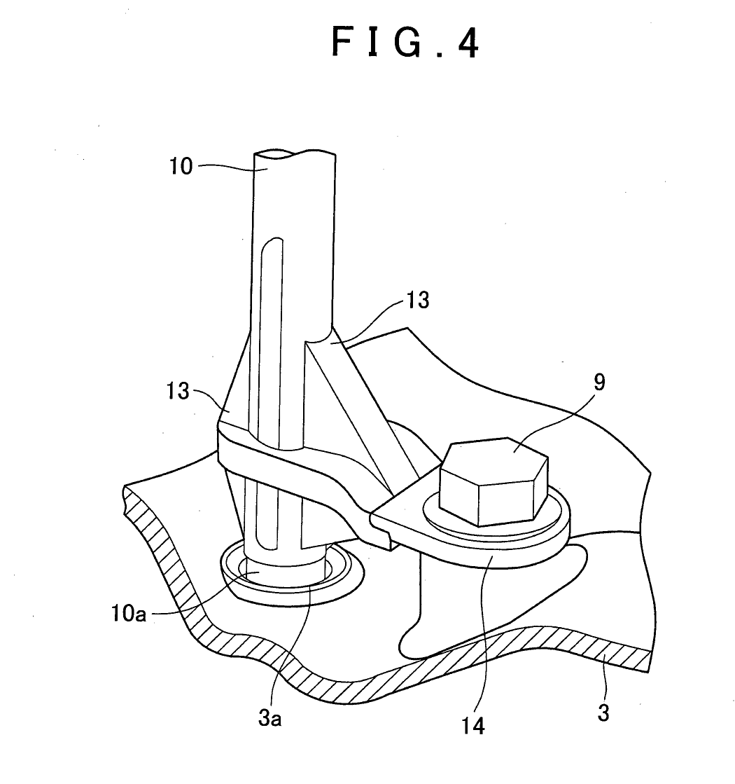

FIG. 3 is an enlarged sectional view of the cooling pipe 10 and a peripheral area of a fixed portion thereof. Further, FIG. 4 is an enlarged perspective view around a fixed portion of the front end 10a of the cooling pipe 10. A rubber bush 17 is press-fitted into the rear end 10b (a rear-cover-side end) of the cooling pipe 10. A tip of the rubber bush 17 is press-fitted into the press-fitting hole 4a provided on a back surface of the rear cover 4. An overall length H of the rubber bush 17 in a state where the cooling pipe 10 is incorporated therein is shorter than a natural length of the rubber bush 17. This is because the cooling pipe 10 including the rubber bush 17 is sandwiched between the case 3 and the rear cover 4 so that the cooling pipe 10 receives a compressive load. Note that the rubber bush 17 corresponds to an example of the elastic member.

The front end 10a of the cooling pipe 10 is press-fitted into a press-fitting hole 3a provided in the case 3, and a flange 14 projecting from around the front end 10a is fastened and fixed to the case 3 with a bolt 9. That is, the cooling pipe 10 is firmly fixed to the case 3. Further, a reinforcement rib 13 is provided in the vicinity of the flange 14. Note that a main body of the cooling pipe 10 is made of resin, but a tip of the flange 14 is made of metal, and has a strength that allows the tip of the flange 14 to tolerate bolt fastening.

The reinforcement rib 13 is provided close to one end 10a of the cooling pipe 10, that is, close to that end of the cooling pipe 10 which is placed on a side farther from the rear cover 4. Further, the rib 13 is provided between a side surface of the cooling pipe 10 and the flange 14 for bolt fastening. The rib 13 has a generally triangular shape between the side surface of the cooling pipe 10 and the flange 14. The rib 13 is provided on either side of the cooling pipe 10. When the rib 13 is viewed from a direction (X-direction) that is perpendicular to the cooling pipe 10 and the flange 14 intersecting with the cooling pipe 10, the rib 13 is provided in four spaces divided by the cooling pipe 10 and the flange 14 so as to surround a center where the cooling pipe 10 and the flange 14 intersect with each other. The rib 13 increases a strength of the cooling pipe 10 and a strength of the flange 14.

Next will be described a function of the cooling pipe 10 configured such that the one end 10a is firmly fixed to the case 3, and the other end 10b is welded with pressure to (press-fitted into) the back surface of the rear cover 4 via the rubber bush 17. Note that, in the cooling pipe 10, the other end 10b is welded with pressure to (press-fitted into) the back surface of the rear cover 4 via the rubber bush 17. As illustrated in FIGS. 1 to 3, a peripheral edge of the rear cover 4 is fixed to the case 3 with the bolts 9, and the cooling pipe 10 is welded with pressure to the back surface of the rear cover 4 inside the peripheral edge. That is, the back surface of the rear cover 4 is a surface facing the inside of the case 3. As described above, the rear cover 4 is thin, and if the cooling pipe 10 is not provided or if the cooling pipe 10 is not firmly fixed to the case, the rear cover 4 may vibrate like a diaphragm. Note that the vibration herein is vibration excited by rotation of the rotor. In the motor 2 of the embodiment, the other end 10b of the cooling pipe 10 is welded with pressure to (press-fitted into) the back surface of the rear cover 4 via the rubber bush 17, and the one end 10a is firmly fastened and fixed to the case 3. The rear cover 4 vibrates in the Z-axis direction in the figures, but the cooling pipe 10 applies a load to the rear cover 4 in the Z-axis direction. When the rear cover 4 is going to be displaced toward the cooling pipe 10 due to vibration, the cooling pipe 10 resists this. Further, when the rear cover 4 is going to be displaced in a direction away from the cooling pipe 10, the rubber bush 17 press-fitted into the cooling pipe 10 dissipates vibrational energy by friction of its press-fitting portion. Thus, the vibration of the rear cover 4 is restrained.

As such, in the motor 2 of the embodiment, the cooling pipe 10 provided so as to cool the stator is also used for vibration restraint of the rear cover 4, thereby achieving low vibration at a low cost. Note that the cooling pipe 10 is originally sandwiched between the case 3 and the rear cover 4 as described in JP 2013-027229 A. In view of this, if the cooling pipe 10 is just supported, it is not necessary to fix the cooling pipe 10 with bolts. In the motor 2 of the present embodiment, the cooling pipe 10 configured such that both sides thereof are sandwiched is daringly fastened and fixed, so as to increase a vibration restraint effect of the rear cover 4.

The following describes a point to keep in mind in regard to the technique described in the above embodiment. The motor of the present embodiment includes only one cooling pipe, but the motor may include a plurality of cooling pipes. As more cooling pipes abut with the back surface of the cover, the vibration restraint effect increases. In the motor of the present embodiment, the cooling pipe 10 extends in parallel to the axis of the rotor 21. The cooling pipe should extend in the axis direction of the rotor, but may extend so as to be inclined relative to the axis of the rotor, for example. The technique described in the above embodiment is suitable for a drive motor for an electric vehicle including a hybrid vehicle. However, the technique of the above embodiment is not limited to the electric vehicle.

The concrete embodiment of the invention has been described in detail, but the embodiment is only an example and does not limit the invention according to Claims. A technique according to Claims includes embodiments obtained by variously modifying or altering the concrete embodiment exemplified as above. Technical elements described in the present specification or the drawings exhibit a technical usability solely or in various combinations, and are not limited to combinations as described in Claims as of filing the present application. Further, the technique exemplified in the present specification or the drawings can achieve a plurality of objects at the same time, and has a technical usability by achieving one of those objects.

1. A rotary electric machine comprising:
a case housing a rotor and a stator in the case, the case having an opening at one end of the case in an axis direction of the rotor;
a cover fixed to a peripheral edge of the opening of the case, the cover configured to cover the opening; and
a cooling pipe placed adjacent to the stator inside the case, the cooling pipe extending in the axis direction, one end of the cooling pipe being configured to abut on a back surface of the cover via an elastic member, and the other end of the cooling pipe being fastened and fixed to the case, wherein
the fixation of the other end of the cooling pipe to the case is made by bolt fastening.

2. The rotary electric machine according to claim 1, wherein
a rib is provided in the other end of the cooling pipe.

3. The rotary electric machine according to claim 1, wherein
the elastic member receives a compressive load between the cover and the one end of the cooling pipe.

4. The rotary electric machine according to claim 1, wherein
the cooling pipe has holes which discharges a refrigerant.
